(19) United States
(12) Patent Application Publication
(10) Pub. No.: US 2012/0178455 A1
(43) Pub. Date: Jul. 12, 2012

(54) RADIO BASE STATION AND HANDOVER INSTRUCTING METHOD

(75) Inventor: Tetsuro SATO, Kanagawa (JP)

(73) Assignee: PANASONIC CORPORATION, Osaka (JP)

(21) Appl. No.: 13/497,229

(22) PCT Filed: Sep. 22, 2010
(86) PCT No.: PCT/JP2010/005740

§ 371 Date: Mar. 20, 2012

(30) Foreign Application Priority Data
Sep. 29, 2009 (JP) 2009-224470

(51) Int. Cl. H04W 36/32

(52) U.S. Cl. 455/436

(57) ABSTRACT

A radio base station wherein when UE connected to an LTE access network performs a CS Fallback, the time required for the CS Fallback can be reduced. An eNB (100), which moves in a cell providing a first service and further covers a cell providing a second service different from the first service, gives UE, which is currently connected to the eNB, an instruction of handover to the cell providing the first service. In the eNB: a terminal position predicting unit (103) predicts, based on the position, moving speed or traveling direction of the UE, a position of the UE at the handover timing; a determining unit (105) determines, based on the position of the UE at the handover timing, a handover destination of the UE from among a plurality of cells providing the first services; and an instructing unit (106) transmits, to the UE, a handover instruction that is an instruction of handover to the cell of the handover destination.

### TECHNICAL FIELD

The present invention relates to a radio base station and a handover instructing method.

### BACKGROUND ART

At present, in 3GPP (3rd Generation Partnership Project) that is an international standardization organization, LTE (Long Term Evolution) technique is being studied. In the LTE, only a packet switching network is provided, a service (speech communication, short message, or the like) provided by a 20 (2nd generation)/3G (3rd generation) circuit switching network (Circuit Switching) is provided by using IMS (IP Multimedia Subsystem). For a case that the IMS is not used, CS (Circuit Switched) Fallback technique is also being studied (for example, see Non-patent Literature 1).

The CS Fallback technique is a technique that switches (hands over), a radio access network (hereinafter referred to as an LTE access network) of the LTE serving as a packet switching network into a radio access network (for example, GSM (Global System for Mobile Communications) or UTRAN (UMTS Terrestrial Radio Access Network)) of a circuit switching network. More specifically, by using the CS Fallback technique, a service such as data communication is provided by using the packet switching network, and a service such as speech communication is provided by using the circuit switching network.

For example, a mobile terminal apparatus (hereinafter, referred to as UE (User Equipment) such as a mobile telephone cannot use a service (for example, a speech communication service or a short messaging service) using a circuit switching network such as the GSM or the UTRAN when the mobile terminal is connected to an LTE access network. Thus, in the conventional CS Fallback technique, the UE connected to an LTE radio access network serving as a packet network hands over a connection destination from an LTE access network to a radio access network serving as a circuit switching network (CS Fallback is performed). In this manner, the UE can use a service (for example, a speech communication service or a short messaging service) using a circuit switching network.

### CITATION LIST

### Non-Patent Literature

### NPL 1

3GPP TS 23.272 V8.3.0, “Circuit Switched (CS) fallback in Evolved Packet System (EPS); Stage 2 (Release 8),” Match 2009

### SUMMARY OF INVENTION

### Technical Problem

In normal handover, the UE measures a radio status of its own apparatus (Measurement) and notifies a measurement result to the network (Measurement Report). The network side determines on the basis of a Measurement Report from the UE whether handover of the UE is performed. When the network side determines that the handover is performed, the network transmits an instruction (Handover Command) of the handover to the UE. The UE performs the handover according to the Handover Command (Access Procedure). Thus, the network side and the UE understand a radio status of a cell (radio access network) of a handover destination of the UE and start the handover when a condition to execute the handover is satisfied.

On the other hand, in the CS Fallback that is the conventional art described above, a start timing of the handover is determined by a factor different from that of reasons of the UE and network side. For example, when a call-in is made in a speech communication, a timing at which an unspecified UE calls in is a timing at which handover is started. For this reason, the timing at which the unspecified UE calls in is not always a timing (timing at which a condition to execute overhand is satisfied) suitable for performing handover on the UE and the network side. This also applies to a case in which a call-out is made in a speech communication or a service such as a short message is used.

A standardizing effort of a small base station (Home eNB) is taken in the LTE. For example, it is supposed that a small base station (Mobile eNB) is installed in a movable space such as a train.

For this reason, when the UE that is connected to a Mobile eNB network (LTE access network) performs handover (CS Fallback) to a circuit switching network by using the conventional art, depending on a start timing of the CS Fallback (for example, call-in timings of a speech communication), a time from when the UE starts the CS Fallback to when the UE can use a service of the circuit switching network (more specifically, a time required for the CS Fallback) may become long. In this case, a problem in which the UE cannot easily use the service of the circuit switching network (for example, a speech communication service or a short messaging service) is posed.

For example, when the Mobile eNB moves, the LTE access network moves. For this reason, a handover destination (circuit switching network) that is optimum when a UE located in the LTE access network performs Measurement may be different from a handover destination (circuit switching network) that is optimum when the UE receives a Handover command to actually perform handover (to perform Access Procedure). More specifically, while the UE located in the Mobile eNB network performs CS Fallback, the circuit switching network serving as an optimum handover destination may change.

For example, as shown in FIG. 1, a case in which a Mobile eNB that covers an LTE access network moves from cell 1 (circuit switching network) to cell 2 (circuit switching network) near a boundary between cell 1 and cell 2. In this case, on the network side, on the basis of a Measurement Report from a UE that connects to the Mobile eNB shown in FIG. 1, it is assumed that cell 1 is determined to be optimum as a handover destination of the UE.

However, as shown in FIG. 1, since the Mobile eNB moves toward cell 2, when the UE receives a Handover Command and actually performs handover, the UE is highly likely located in cell 2. More specifically, the optimum handover destination obtained when the UE actually performs handover is probably cell 2. More specifically, a circuit switching network (cell 1) determined as the handover destination of the UE is different from a circuit switching network (cell 2) that is an optimum handover destination obtained when the UE actually performs handover. In this case, after the UE completes the handover to cell 1, a handover from cell 1 to cell 2 needs to be performed again. For this reason, as a result, a time required for CS Fallback becomes long.

In FIG. 1, since the Mobile eNB moves toward cell 2, when the UE actually performs handover, the UE may have moved into cell 2 except for a portion near the boundary between cell 1 and cell 2. Thus, the UE may not be able to connect to cell 1 when the UE performs handover to cell 1 according to a Handover Command (handover destination: cell 1) from the network side.

In this manner, since the position of the UE changes when the Mobile eNB (LTE access network) moves, while the UE that connects to the Mobile eNB (LTE access network) performs CS Fallback, an optimum handover destination may change. For this reason, an optimum handover destination obtained when the UE actually performs handover (performs Access Procedure) may not be able to be determined on the network side. Furthermore, on the network side, the optimum handover destination obtained when the UE actually performs handover cannot be determined, and, therefore, a Handover Command that instructs handover to an erroneous handover destination is transmitted to the UE. In this case, the UE has moved to a position where the UE cannot connect to the erroneous handover destination, and the UE may not be able to connect to the instructed handover destination. For this reason, when a UE located in the LTE access network performs CS Fallback, a time required for the CS Fallback may become long.

It is an object of the present invention to provide a radio base station and a handover instructing method that can shorten a time required for CS Fallback when a UE connected to an LTE access network performs CS Fallback.

### Solution to Problem

A radio base station according to the present invention that moves in a cell that provides the first service, covers a cell that provides the second service different from the first service, and instructs a mobile terminal connected to the radio base station to perform handover to the cell that provides the first service, employs a configuration having: a predicting section that predicts a position of the mobile terminal in the handover state on the basis of a position, a moving speed, or a traveling direction of the mobile terminal; a specifying section that specifies a handover destination of the mobile terminal from a plurality of cells that provide a plurality of first services on the basis of the position of the mobile terminal in the handover state; and a instructing section that transmits a handover instruction that instructs handover to a cell of the handover destination to the mobile terminal.

A handover instructing method according to the present invention, in a radio base station that moves in a cell that provides a first service, covers a cell that provides a second service different from the first service, and instructs a mobile terminal connected to its own station to perform handover to the cell that provides the first service, includes: predicting a position of the mobile terminal in the handover state on the basis of a position, a moving speed, or a traveling direction of the mobile terminal; specifying a handover destination of the mobile terminal from a plurality of cells that provide a plurality of first services on the basis of the position of the mobile terminal in the handover state; and transmitting a handover instruction that instructs handover to a cell of the handover destination to the mobile terminal.

### Advantageous Effects of Invention

According to the present invention, when a UE located in the LTE access network, a time required for the CS Fallback can be reduced.

### BRIEF DESCRIPTION OF DRAWINGS

FIG. 1 is a diagram showing a radio communication system according to the present invention;

FIG. 2 is a block diagram showing a configuration of an eNB according to Embodiment 1 of the present invention;

FIG. 3 is a block diagram showing a configuration of a UE according to Embodiment 1 of the present invention;

FIG. 4 is a block diagram showing a configuration of an eNB according to Embodiment 3 of the present invention; and

FIG. 5 is a diagram showing a flow of a handover instructing process according to Embodiment 3 of the present invention.

### DESCRIPTION OF EMBODIMENTS

Embodiments of the present invention will be described below in detail with reference to the accompanying drawings.

In a radio communication system according to the present invention, an LTE access network such as the internet, a LAN, or a cellular network of a packet switching type that can perform transmission by an IP packet, and a radio access network serving as a circuit switching network such as a fixed telephone network or a cellular network of a circuit switching type that can perform transmission by circuit switching are mixed.

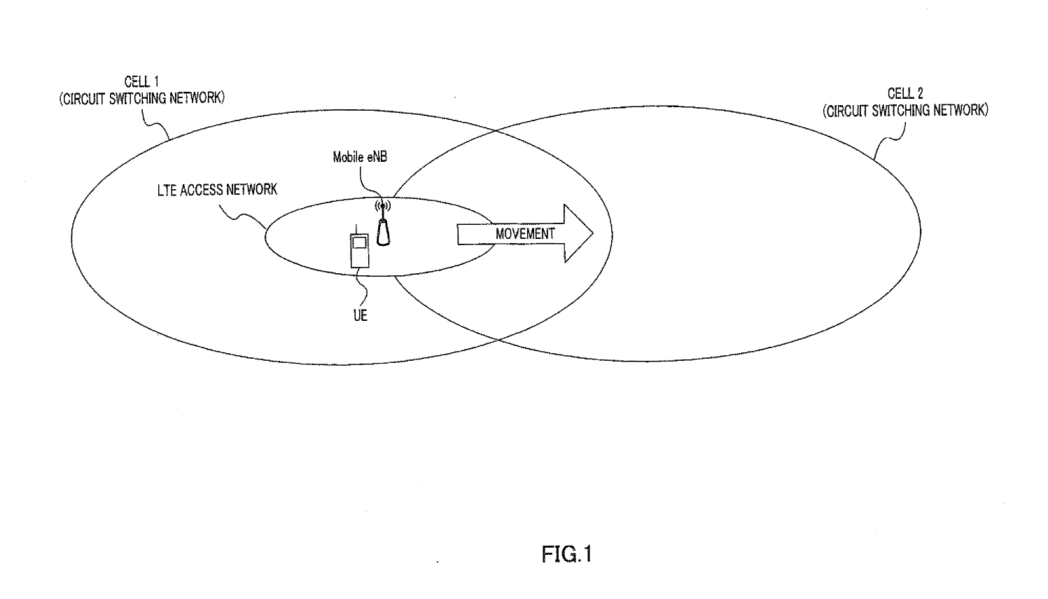

The radio base station (hereinafter referred to as an eNB) according to the present invention is a Mobile eNB that covers an LTE access network (cell) that provides a service using a packet switching network. The eNB according to the present invention, for example, in a radio communication system shown in FIG. 1, moves on cells (cells 1 and 2 in FIG. 1) that provide a service using a circuit switching network.

In the following explanation, for descriptive convenience, a case in which an eNB is used as one apparatus obtained by collecting networking functions on a network side will be described. However, in the present invention, all the networking functions on the network side need not be executed by one eNB, and the networking functions may be separately executed in a plurality of apparatuses that are different from each other. For example, with an LTE, the networking functions according to the present invention can be separately executed by an eNB, an RNS/BSS, an MME, and an MSC/VLR, respectively.

### Embodiment 1

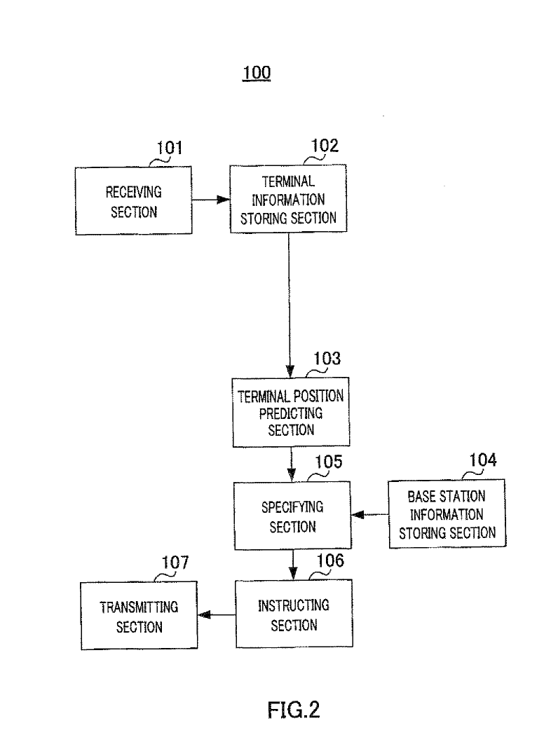

A configuration of an eNB according to the present embodiment is shown in FIG. 2.

In eNB 100 shown in FIG. 2, receiving section 101 receives information from a UE side. For example, as the information from the UE side, terminal information including position information representing a position of a UE that is measured by the UE using a GPS, speed information representing a moving speed of UE, traveling direction information representing a traveling direction of a UE acquired by the UE using a gyro sensor, and the like is known. As the information from the UE side, a measurement result (Measurement Report) of a radio status and information related to CS Fallback such as an execution result message (Handover Complete) of handover are also known. Receiving section 101 outputs the terminal information of the received information to terminal information storing section 102. Terminal information storing section 102 stores terminal information input from receiving section 101. When no position information is received from the UE, terminal information storing section 102 may specify the position of the UE by using a receiving direction and a delay time of a radio wave transmitted from the UE and store the position of the specified UE as position information. Terminal information storing section 102 may calculate the speed information and the traveling direction information by combining histories such as past position information.

Terminal position predicting section 103 predicts a position to which the UE moves in the near future (future) on the basis of terminal information (position information, speed information, or traveling direction information) stored in terminal information storing section 102. More specifically, terminal position predicting section 103 predicts, on the basis of the terminal information stored in terminal information storing section 102, a position of the UE at time at which the UE actually perform handover (or time at which eNB 100 transmits a handover instruction (Handover Command)). For example, terminal position predicting section 103, by using present position information of the UE and past position information of the UE of the terminal information, predicts a moving path of the UE in the near future (future) when the UE moves thereafter as in a path (moving speed, traveling direction, and the like) through which the UE moves from past to present, and by this means predicts the position of the UE in the near future (future). Alternatively, by using the speed information and the traveling destination information of the UE of the terminal information, terminal position predicting section 103 calculates a direction and a distance in which the UE will move in the future, and by this means predicts a position of the UE in the near future (future). Terminal position predicting section 103 outputs position prediction information representing the position of the UE in a handover state serving as a prediction result to specifying section 105.

Base station information storing section 104 stores arrangement information representing an arrangement of the eNB managed by its own station (network side) and base station information including cell information or the like. The base station information can be shared by different eNBs. The base station information is updated when a new eNB is installed. When a radio status such as a radio field intensity changes, base station information can be exchanged between the eNBs.

Specifying section 105, on the basis of the position prediction information (position of the UE in the handover state) input from terminal position predicting section 103 and the base station information stored in base station information storing section 104, specifies a cell (radio access network) serving as a handover destination when the UE performs CS Fallback, from a plurality of cells (circuit switching network). Specifying section 105, on the basis of the position prediction information and the base station information of the UE to which CS Fallback is performed, calculates time (time at which the UE can connect to a cell serving as a handover destination) at which the UE can actually perform handover (Access Procedure) in the cell serving as the handover destination. Specifying section 105 outputs cell information that is a determination result and represents a cell (radio access network) serving as the handover destination and time information representing time at which the UE can actually perform the handover to instructing section 106.

Instructing section 106 transmits a handover instruction (Handover Command) to which the cell information input from specifying section 105 is added to the UE through transmitting section 107. More specifically, instructing section 106 instructs the UE to perform handover to a cell (radio access network) represented by the cell information. In this case, instructing section 106 transmits the handover instruction (Handover Command) to the UE at the time shown in the time information input from specifying section 105.

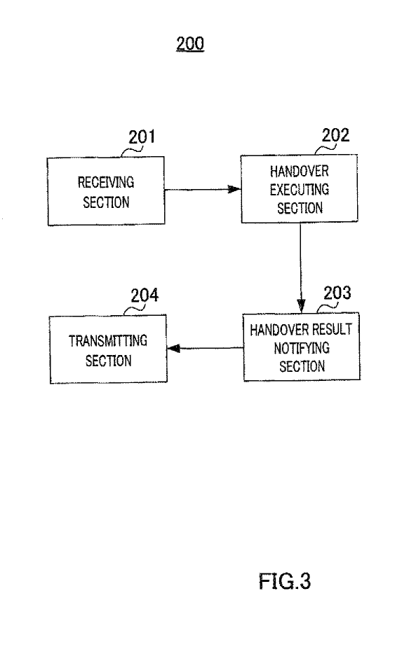

A configuration of a UE according to the present embodiment is shown in FIG. 3.

In UE 200 shown in FIG. 3, receiving section 201 receives a handover instruction (Handover Command) transmitted from eNB 100 (FIG. 2) and outputs the received Handover Command to handover executing section 202. Cell information representing information of a cell (radio access network) of a connection destination is added to the Handover Command.

When handover executing section 202 receives the Handover Command input from receiving section 201, handover executing section 202 performs handover (CS Fallback) to a cell (radio access network) represented by the cell information added to the Handover Command.

Handover result notifying section 203 notifies a network side of a handover result message (Handover Complete) representing that handover (CS Fallback) in handover executing section 202 is completed through transmitting section 204. Handover result notifying section 203 transmits the Handover Complete to a cell (radio access network) that is newly accessed.

A handover process in eNB 100 (FIG. 2) and UE 200 (FIG. 3) according to the present embodiment will be described below in detail.

A timing at which the CS Fallback is a call-in state in a speech communication, a call-out state in a speech communication, or the start of service. In any one of the call-in state in a speech communication and the call-out state in a speech communication, a handover instruction (Handover Command) is transmitted from eNB 100 (network side) to UE 200. In this case, as an example, a case in which a call-in is made in a speech communication to UE 200 connected to eNB 100 (LTE access network) will be described below.

More specifically, eNB 100 accepts a call-in in a speech communication from an unspecified UE to UE 200.

Since UE 200 that receives the call-in is connected to eNB 100 (LTE access network), eNB 100 determines that CS Fallback to a circuit switching network needs to be performed to UE 200. In general, a network side (in this case, eNB 100) of a mobile telephone system performs authentication when a mobile terminal (in this ease, UE 200) connects to the LTE access network to register the mobile terminal in a location server. For this reason, the network side can confirm as needed whether the mobile terminal is connected to the LTE access network. The network side confirms a terminal capability (UE Capability) of a mobile terminal when the mobile terminal connects to the LTE access network. For this reason, the network side also recognizes whether the mobile terminal is of a model corresponding to CS Fallback. In this manner, eNB 100 can determine whether UE 200 that receives a call-in connected to its own apparatus (LTE access network) and determine whether CS Fallback to a circuit switching network needs to be performed to UE 200.

Terminal position predicting section 103 of eNB 100 predicts a position of UE 200 in the near future (future), i.e., a position of UE 200 in a handover state in a handover state. For example, terminal position predicting section 103, by using the terminal information (position information, speed information, or traveling direction information of UE 200) stored in terminal information storing section 102, predicts a position of UE 200 after UE 200 moves from the present time to time at which UE 200 actually performs handover (Access Procedure).

For example, as shown in FIG. 1, a case in which UE 200 moves from cell 1 to cell 2 will be described below. In FIG. 1, for example, it is assumed that the present position information of UE 200 represents a position near a boundary between cell 1 and cell 2 and that the past position information of UE 200 represents a position in cell 1 at a position except for the boundary between cell 1 and cell 2. At this time, for example, terminal position predicting section 103, by using the past position (cell 1) of UE 200 and the present position (near the boundary between cell 1 and cell 2) of UE 200, predicts that a position of the UE in a handover state is a position in cell 2 (i.e., the position except for the boundary between cell 1 and cell 2). Alternatively, for example, when a traveling direction of UE 200 represented by the traveling direction information is a direction to cell 2 as shown in FIG. 1, terminal position predicting section 103 calculates a distance for which UE 200 moves at a moving speed represented by the speed information of UE 200 from the present position of UE 200 (near the boundary between cell 1 and cell 2 shown in FIG. 1) in a traveling direction (toward cell 2) to predict that the position of the UE in the handover state is a position in cell 2 (i.e., a position except for the boundary between cell 1 and cell 2).

Next, specifying section 105 of eNB 100, on the basis of the position prediction information representing the position of UE 200 predicted by terminal position predicting section 103 and the base station information stored in base station information storing section 104, determines a cell (radio access network) to which UE 200 should perform handover and time at which UE 200 should perform handover (time at which Access Procedure should be performed).

For example, when the position of UE 200 predicted by terminal position predicting section 103 is a position in cell 2 shown in FIG. 1, specifying section 105 determines that handover is preferably performed to cell 2 of cell 1 and cell 2 shown in FIG. 1 to generate cell information representing cell 2. Specifying section 105, by using the position information of UE 200 and base station information of a cell (in this case, cell 2) serving as a handover destination, calculates time at which. UE 200 can actually perform handover (Access Procedure) (time at which UE 200 can connect to cell 2 serving as a handover destination).

Instructing section 106 of eNB 100 transmits a handover instruction (Handover Command) to which cell information representing a cell (radio access network) (in this case, cell 2 shown in FIG. 1) serving as a handover destination is added to UE 200. At this time, after instructing section 106 waits until the time at which specifying section 105 is calculated (time at which UE 200 can connect to cell 2 serving as the handover destination), instructing section 106 transmits the Handover Command to which the cell information is added, to UE 200.

On the other hand, when handover executing section 202 of UE 200 receives the Handover Command from eNB 100, CS Fallback is performed to the cell (radio access network) represented by the cell information added to the Handover Command.

When handover result notifying section 203 of UE 200 succeeds in CS Fallback, a handover result (Handover Complete) is transmitted to the network side through the cell (radio access network) serving as the handover instruction.

In this manner, when UE 200 that is connected to eNB 100 (LTE access network) performs CS Fallback, eNB 100 specifies an optimum handover destination at a timing at which UE 200 actually performs handover (performs Access Procedure). For example, in FIG. 1, when UE 200 specifies that an optimum handover destination at a timing at which UE 200 performs handover is cell 2, even though a present position of UE 200 is cell 1, eNB 100 instructs cell 2 as the handover destination. More specifically, eNB 100 instructs the optimum handover destination at a time when UE 200 actually performs handover to UE 200, regardless of the position of UE 200 at this time. Thus, UE 200 performs handover according to the instruction (Handover Command) from eNB 100 to make it possible to connect to an optimum cell (radio access network). In this manner, even though an optimum handover destination changes while UE 200 that is connected to its own apparatus (LTE access network) performs CS Fallback, eNB 100 can instruct the optimum handover destination (in this case, cell 2) at time at which UE 200 actually performs handover to UE 200. For this reason, in UE 200, handover is not performed to an erroneous handover destination (in this case, cell 1), a time required for CS Fallback can be reduced.

When, in general, the CS Fallback needs to be performed in UE 200, eNB 100 desirably immediately transmits a handover instruction (Handover Command) to cause UE 200 to immediately perform CS Fallback. However, depending on moving paths of UE 200 in the future, even though eNB 100 immediately transmits the handover instruction to the handover destination specified by predicting the position of UE 200 in a handover state, UE 200 has not moved to a position at which UE 200 connects to the handover destination. For this reason, UE 200 may not be able to perform handover. In contrast to this, in the present embodiment, eNB 100 calculates time (time at which Access Procedure is performed) at which UE 200 actually performs handover. eNB 100 waits without transmitting a Handover Command until it is the calculated time (i.e., until time at which UE 200 can connect to the handover destination). In this manner, even though UE 200 immediately performs handover when receiving the Handover Command, UE 200 can reliably connect to the optimum handover destination. That is, when UE 200 that is connected to eNB 100 (LTE access network) performs CS Fallback, UE 200 can be prevented from not connecting to the cell (radio access network) serving as a handover destination due to too early handover instruction.

In this manner, according to the present embodiments, the eNB predicts a position of the UE that is connected to its own apparatus (LTE access network) in a handover state, and specifies a handover destination (circuit switching network) of the UE. In this manner, according to the movement of eNB or the movement of UE, even though an optimum handover destination obtained when the eNB determines the handover destination of the UE is different from an optimum handover destination obtained when the UE actually performs handover, eNB can instruct to the UE the optimum handover destination when the UE actually performs handover. In this manner, without performing handover to an erroneous handover destination (i.e., an optimum handover destination obtained before UE moves), the UE can perform handover to an optimum handover destination (i.e., an optimum handover destination obtained after the UE moves). Thus, according to the present embodiment, when the UE that is connected to the LTE access network performs CS Fallback, a time required for the CS Fallback can be reduced.

Furthermore, according to the present embodiment, the eNB waits for transmission of a handover instruction (Handover Command) until the UE can connect to a handover destination. In this manner, when the UE receives the handover instruction, the UE is in a state to be able to connect to a connection destination of handover. For this reason, the UE can reliably connect to the connection destination.

### Embodiment 2

In Embodiment 1, a case in which the eNB does not transmit a handover instruction (Handover Command) until the UE can connect to the handover destination was described. In contrast to this, in the present embodiment, an eNB adds time information related to time at which a UE can connect to a handover destination to a Handover Command, and the UE, on the basis of the time information added to the Handover Command, waits until the UE can connect to the handover destination.

The present embodiment will be described in detail below. In eNB 100 (FIG. 2) and UE 200 (FIG. 3) according to the present embodiment, the same components performing as in Embodiment 1 will be omitted.

In eNB 100 according to the present embodiment, instructing section 106 transmits, to the UE, a handover instruction (Handover Command) that is input from specifying section 105 and to which cell information and time information are added to the UE through transmitting section 107. In this case, the time information generated by specifying section 105 may be information representing a time at which the UE can connect to a cell serving as a handover destination or information representing a time (standby time) from a time when the Handover Command is transmitted until a time when the UE can connect to the cell serving as the handover destination.

In UE 200 according to the present embodiment, when handover executing section 202 receives as input the Handover Command input from receiving section 201, handover executing section 202 performs handover (performs Access Procedure) according to the cell information and the time information added to the Handover Command. For example, when a standby time is instructed as time information, handover executing section 202 performs handover to a cell represented by cell information, when the standby time is elapsed after a Handover Command is received. When the UE instructs time at which the UE can connect to a cell serving as a handover destination as time information, handover executing section 202 waits until the instructed time and performs handover at the instructed time.

In this manner, UE 200 does not perform handover (does not perform Access Procedure) until the standby time represented by the time information added to the Handover Command has elapsed (or until the time represented by the time information) after the Handover Command is received, i.e., UE 200 can connect to the cell serving as the handover destination represented by the cell information. In other words, UE 200 performs handover after UE 200 can connect to the cell serving as the handover destination (performs Access Procedure). For this reason, as in Embodiment 1, when UE 200 that is connected to eNB 100 (LTE access network) performs CS Fallback, UE 200 can be prevented from not connecting to a cell (radio access network) serving as a handover destination due to too early handover instruction.

As in Embodiment 1, eNB 100 can instruct an optimum handover destination at time at which UE 200 actually performs handover to UE 200. More specifically, since UE 200, as in Embodiment 1, performs handover (performs Access Procedure) according to the instruction (Handover Command) from eNB 100, UE 200 does not perform handover to an erroneous handover destination.

In this manner, according to the present embodiment, even though the UE receives the handover instruction (Handover Command), the UE waits until the UE can connect to the handover destination. For this reason, the UE can reliably connect to the handover destination. As in Embodiment 1, the eNB predicts a position of the UE in a handover state and specifies a handover destination of the UE. Thus, according to the present embodiment, as in Embodiment 1, when the UE located in the LTE access network performs CS Fallback, a time required for the CS Fallback can be reduced.

### Embodiment 3

When an eNB is installed in an automobile, a train, or the like (Mobile eNB), the eNB can be moved. For example, when an eNB is installed in a means of public transportation such as a train or a bus, convenience for a user may be enhanced. A moving path (route) of such a means of transportation is set in advance, and the means of transportation is driven according to a time table. More specifically, when an eNB is installed in a means of transportation, time at which the eNB moves and a location to which the eNB moves can be easily specified. When a user who owns a UE uses a means of transportation in which an eNB is installed, the UE and the eNB move together.

In the present embodiment, when the UE and its own apparatus move together, the eNB predicts the position of the UE in a handover state on the basis of a moving path of its own apparatus.

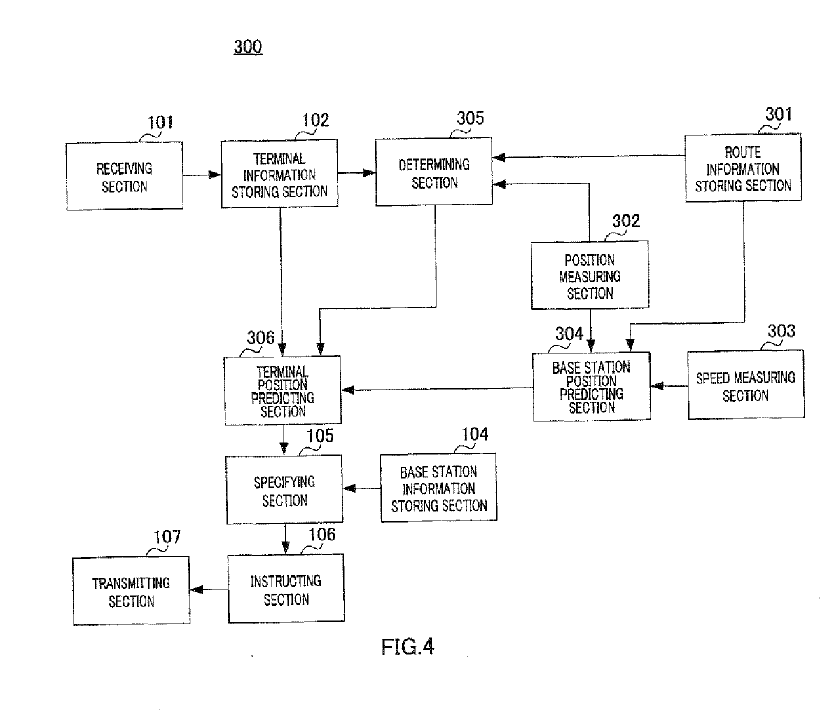

A configuration of the eNB according to the present embodiment will be described below. A configuration of eNB 300 according to the present embodiment is shown in FIG. 4. The same reference numerals as in FIG. 2 (Embodiment 1) denote the same parts in FIG. 4, and a description thereof will be omitted.

In eNB 300 according to the present embodiment, route information storing section 301 stores route information representing a moving route of its own apparatus. More specifically, when its own apparatus is installed in a means of transportation (train, bus, or the like), route information storing section 301 stores information representing a moving route of the means of transportation and route information including information representing a driving time table of the means of transportation.

Position measuring section 302 measures a present position of its own apparatus. For example, position measuring section 302 measures the present position of its own apparatus by using a GPS. Position measuring section 302 outputs information representing the measured present position of its own apparatus to base station position predicting section 304 and determining section 305.

Speed measuring section 303 measures a moving speed of its own apparatus and a traveling direction of its own apparatus. For example, speed measuring section 303 measures the moving speed of its own apparatus by using a speed meter of a means of transportation (vehicle or train) in which its own apparatus is installed and measures the traveling direction of its own apparatus by using a gyro sensor. Speed measuring section 303 outputs information representing the measured moving speed of its own apparatus and information representing the traveling direction of its own apparatus to base station position predicting section 304.

Base station position predicting section 304, on the basis of the route information stored in route information storing section 301, the information (present position of its own apparatus) input from position measuring section 302, or the information (moving speed and traveling direction of its own apparatus) input from speed measuring section 303, predicts a position of its own apparatus in the near future (future), i.e., a position to which its own apparatus moves when its own apparatus moves from the present time until the terminal performs handover. Base station position predicting section 304 outputs base station position prediction information representing a position of its own apparatus serving as a prediction result to terminal position predicting section 306. Only when base station position predicting section 304 is requested by terminal position predicting section 306 to generate base station position prediction information, base station position predicting section 304 may generate the base station position prediction information.

Determining section 305 compares the terminal information (position information, speed information, or traveling direction information) stored in terminal information storing section 102 with the route information of its own apparatus stored in route information storing section 301, or the information (information representing the position of its own apparatus) input from position measuring section 302 to determine whether or not the UE and its own apparatus move together. Determining section 305 outputs a determination result representing whether its own apparatus and the UE move together to terminal position predicting section 306.

Terminal position predicting section 306, on the basis of the determination result input from determining section 305, predicts a position of the UE in the near future (future), i.e., a position of the UE in a handover state in the handover state. More specifically, when the determination result from determining section 305 represents that its own apparatus and the UE do not move together, terminal position predicting section 306, as in Embodiment 1, predicts the position of the UE in the handover state on the basis of the terminal information stored in terminal information storing section 102. On the other hand, when the determination result from determining section 305 represents that its own apparatus and the UE move together, terminal position predicting section 306 predicts a position of the UE in a handover state on the basis of the base station position prediction information input from base station position predicting section 304.

Details of a handover instructing process in eNB 300 (FIG. 4) according to the present embodiment will be described below.

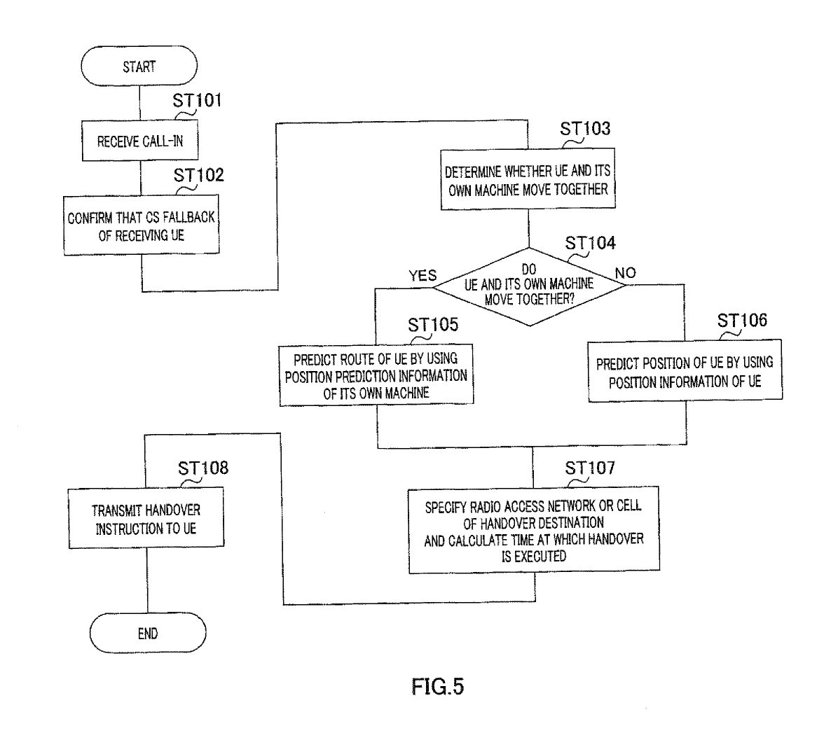

FIG. 5 is a flow chart showing a flow of the handover process in eNB 300.

In FIG. 5, in step (hereinafter referred to as ST) 101, as in Embodiment 1, eNB 300 accepts a call-in of a speech communication from an unspecified UE to UE 200. In ST102, eNB 300 determines that CS Fallback to a circuit switching network needs to be performed to UE 200 because receiving UE 200 is connected to its own apparatus (LTE access network).

In ST103, determining section 305 of eNB 300 determines whether or not UE 200 and its own apparatus are moving together. More specifically, determining section 305 compares the terminal information (position information, speed information, traveling direction information, and the like) of UE 200 stored in terminal information storing section 102 with the information (position information of its own apparatus) input from position measuring section 302 to determine whether or not UE 200 and its own apparatus are moving together. Determining section 305 may compare past position information of UE 200 stored in terminal information storing section 102 with position of its own apparatus measured in the past by position measuring section 302 and determine whether or not a moving inclination of UE 200 is the same as a moving inclination of its own apparatus. Alternatively, determining section 305, by using the terminal information stored in terminal information storing section 102 and the route information of its own apparatus stored in route information storing section 301, may determine whether or not UE 200 moves on the moving route of its own apparatus to determine whether or not UE 200 and its own apparatus are moving together. Alternatively, determining section 305, by using the route information of its own apparatus and information representing a driving time table that are stored in route information storing section 301, may determine whether or not UE 200 moves through a zone between bus stops or stations through which its own apparatus passes. For example, when a user who owns UE 200 is on a bus or a train in which eNB 300 is installed, determining section 305 makes the determination to determine that UE 200 and its own apparatus are moving together.

When the determination result in ST103 represents that UE 200 and its own apparatus are moving together (ST104: YES), in ST105, terminal position predicting section 306 predicts a position of UE 200 in an handover state on the basis of the base station position prediction information input from base station position predicting section 304 to generate position prediction information of UE 200. For example, terminal position predicting section 306 may directly use the base station position prediction information as the position prediction information of UE 200. Alternatively, terminal position predicting section 306 may correct base station position prediction information by a difference between the positions of UE 200 and its own apparatus and use the corrected information as position prediction information of UE 200. For example, when eNB 300 is installed in a train, it is supposed that the position of eNB 300 and the position of UE 200 are separated from each other by a distance corresponding to several cars. In this case, terminal position predicting section 306 corrects the base station position prediction information by the difference between the positions of UE 200 and its own apparatus so as to improve location accuracy shown by the position prediction information of UE 200.

On the other hand, when the determination result in ST103 represents that UE 200 and its own apparatus are not moving together (ST104: NO), in ST106, terminal position predicting section 306, as in Embodiment 1, generates position prediction information of UE 200 by using the terminal information of UE 200 stored in terminal information storing section 102.

In ST107, specifying section 105, as in Embodiment 1, on the basis of the position prediction information of UE 200 predicted by terminal position predicting section 306 and the base station information stored in base station information storing section 104, specifies a cell (radio access network) of a handover destination of UE 200 to generate cell information representing the specified cell. Furthermore, specifying section 105 calculates time at which LIE 200 actually performs handover (Access Procedure) (or a standby time until UE 200 can actually perform handover (Access Procedure)).

In ST108, instructing section 106, as in Embodiment 1, waits until time calculated in ST107, and then transmits a handover instruction (Handover Command) to which the cell information generated in ST107 is added to UE 200. In ST108, instructing section 106, as in Embodiment 2, may transmit the handover instruction (Handover Command) to which both the cell information generated in ST107 and time information representing the standby time calculated in ST107 are added, to UE 200.

In this manner, in the present embodiment, when the UE and the eNB are moving together, the eNB uses position prediction information of its own apparatus as position prediction information of the UE. In this case, when an eNB is installed in a means of transportation or the like the moving route and moving time (driving time) are predetermined, even though the eNB moves, a position of the eNB in a handover state can be easily predicted. Thus, according to the present embodiment, when the UE and the eNB are moving together, the eNB uses the position prediction information of its own apparatus as the position prediction information of the UE to make it possible to easily predict a position of the UE in a handover state in comparison with Embodiment 1. According to the present embodiment, as in Embodiment 1, since the handover destination is specified by predicting the position of the UE in the handover state, when the UE located on the LTE access network performs CS Fallback, a time required for the CS Fallback can be reduced.

The embodiments of the present invention have been described as above.

The disclosure of Japanese Patent Application No. 2009-224470, filed on Sep. 29, 2009, including the specification, drawings and abstract, is incorporated herein by reference in its entirety.

### INDUSTRIAL APPLICABILITY

The present invention can be applied to a radio base station, a radio communication system, and the like that perform switching (CS Fallback) from an LTE access network to a circuit switching network (GSM, UTRAN, or the like) for a mobile terminal apparatus such as a mobile telephone terminal or a mobile information terminal.

### REFERENCE SIGNS LIST

100, 300 eNB
200 UE
101, 201 Receiving section
102 Terminal information storing section
103, 306 Terminal position predicting section
104 Base station information storing section
105 Specifying section
106 Instructing section
107, 204 Transmitting section
202 Handover executing section
203 Handover result notifying section
301 Route information storing section
302 Position measuring section
303 Speed measuring section
304 Base station position predicting section
305 Determining section

1. A radio base station that moves in a cell that provides a first service, covers a cell that provides a second service different from the first service, and instructs a mobile terminal connected to the radio base station to perform handover to the cell that provides the first service, comprising:
a predicting section that predicts a position of the mobile terminal in the handover state on the basis of a position, a moving speed, or a traveling direction of the mobile terminal;
a specifying section that specifies a handover destination of the mobile terminal from a plurality of cells that provide the plurality of the first services on the basis of the position of the mobile terminal in the handover state; and
an instructing section that transmits a handover instruction that instructs handover to a cell of the handover destination to the mobile terminal.

2. The radio base station according to claim 1, wherein the specifying section further calculates time at which the mobile terminal can connect to the cell of the handover destination by using the position, the moving speed, or the traveling direction of the mobile terminal, and
wherein the instructing section transmits the handover instruction at the time to the mobile terminal.

3. The radio base station according to claim 1, wherein the specifying section further calculates time at which the mobile terminal can connect to the cell of the handover destination by using the position, the moving speed, or the traveling direction of the mobile terminal, and
wherein the instructing section transmits the handover instruction to which information representing the time is added.

4. The radio base station according to claim 1, wherein the specifying section further calculates time at which the mobile terminal can connect to the cell of the handover destination by using the position, the moving speed, or the traveling direction of the mobile terminal, and
wherein the instructing section transmits the handover instruction to which information representing the time from time when the handover instruction is transmitted until the time is added.

5. The radio base station according to claim 1, further comprising a determining section that compares the position, the moving speed, or the traveling direction of the mobile terminal with a position or a moving route of the radio base station to determine whether or not the mobile terminal and the radio base station are moving together,
wherein the predicting section predicts a position of the mobile terminal in the handover state on the basis of the position, the moving speed, or the traveling direction of the mobile terminal, when the mobile terminal and the radio base station are determined not being moving together, and predicts a position of the mobile terminal in the handover state on the basis of the position, the moving speed, or the traveling direction of the radio base station, when the mobile terminal and the radio base station are determined moving together.

6. A handover instructing method, in a radio base station that moves in a cell that provides a first service, covers a cell that provides a second service different from the first service, and instructs a mobile terminal connected to the radio base station to perform handover to the cell that provides the first service, comprising:
predicting a position of the mobile terminal in the handover state on the basis of a position, a moving speed, or a traveling direction of the mobile terminal;
specifying a handover destination of the mobile terminal from a plurality of cells that provide the plurality of the first services on the basis of the position of the mobile terminal in the handover state; and
transmitting a handover instruction that instructs handover to a cell of the handover destination to the mobile terminal.
